(19) United States
(12) Patent Application Publication
(10) Pub. No.: US 2026/0092484 A1
(43) Pub. Date: Apr. 2, 2026

(54) HINGE ASSEMBLY

(71) Applicant: Tampco Incorporated, Elkin, NC (US)

(72) Inventor: Travis Dale Bullin, Elkin, NC (US)

(73) Assignee: Tampco Incorporated, Elkin, NC (US)

(21) Appl. No.: 19/343,000

(22) Filed: Sep. 29, 2025

Related U.S. Application Data
(60) Provisional application No. 63/701,214, filed on Sep. 30, 2024.

(51) Int. Cl. E05D 11/10; E05D 3/02

(52) U.S. Cl. CPC E05D 11/1007; E05D 3/02; E05Y 2201/218; E05Y 2900/402

(57) ABSTRACT

A hinge assembly is disclosed comprising an upper portion comprising a central bore and upper portion elongate fingers separated by upper portion elongate grooves extending along a length of the upper portion, a middle portion comprising a central bore and middle portion elongate fingers separated by middle portion elongate grooves extending along a length of the middle portion, and a lower portion comprising a central bore. A hinge rod is configured to be received in the central bore of the lower portion, the central bore of the middle portion and the central bore of the upper portion, and the upper portion elongate fingers are configured to be received within the middle portion elongate grooves and the middle portion elongate fingers elongate fingers are configured to be received within the upper portion elongate grooves. A barrier assembly comprising the hinge assembly is also disclosed.

### CROSS-REFERENCE TO RELATED APPLICATIONS

This application claims priority to U.S. Provisional Application No. 63/701,214, filed Sep. 30, 2024, the entire disclosure of which is hereby incorporated by reference herein.

### TECHNICAL FIELD

The present disclosure generally relates to hinge assemblies that are configured to be used with swinging barriers to provide opening and closing of entry into a space. Specific embodiments of the disclosure pertain to gate hinge assemblies and door hinge assemblies.

### BACKGROUND

Various types of barriers are used to close an area such as a yard, a farm, an industrial space, a building such as a home, an apartment building or a commercial building such as an office or factory. Barriers may also be used to close entry to a space in a vehicle such as a marine vessel, a truck or a train car. As a specific example, various marine vessels including pleasure boats, fishing boats, yachts and ships have swinging gates to restrict access and provide entry to different portions of the marine vessel or to allow entry onto the vessel. Pontoon boats often have gates at the bow and stern of the pontoon boat, and many pontoon boats also have gates on the port and starboard sides of the boat. Another specific example is gates that are used to restrict entry to a yard, a farm or another space.

FIG. 1 shows a prior art gate assembly 10 including a gate hinge 12 comprising a hollow tube that receives a gate 16. A pin 14 protruding from the gate and a plurality of slots 15 in the gate hinge 12 cooperate to hold the gate 16 in a closed position and in one or more open positions. A problem with the hinge 16 shown in FIG. 1 is that the pin and slot do not fit together firmly, and over time, the slot tends to wear, which causes the gate to rattle and not hold the gate firmly in place. In addition, over time the pin can wear down, causing the gate to accidentally swing open, defeating the purpose of the gate, namely, to restrict entry to an open area. Similar considerations apply on any barrier to entry to a space. When a hinge fails, the barrier to entry, for example, a gate or door, may be left in an open position. This could cause a dangerous situation by allowing unrestricted access to areas that are intended to be closed to entry, for example, children or pets on a boat or other vessel are prevented from exiting the boat and falling into the water. It would be desirable to provide hinge assemblies configured for use with a variety of barriers to entry, including doors and gates, which prevent rattling of the hinge and/or unintended opening.

### SUMMARY

One or more embodiments of the disclosure are directed to a hinge assembly comprising an upper portion comprising a central bore and upper portion elongate fingers separated by upper portion elongate grooves extending along a length of the upper portion; a middle portion comprising a central bore and middle portion elongate fingers separated by middle portion elongate grooves extending along a length of the middle portion; a lower portion comprising a central bore; and a hinge rod configured to be received in the central bore of the lower portion, the central bore of the middle portion and the central bore of the upper portion, and the upper portion elongate fingers are configured to be received within the middle portion elongate grooves and the middle portion elongate fingers elongate fingers are configured to be received within the upper portion elongate grooves.

Another aspect pertains to a barrier assembly comprising the hinge assembly described according to one or more embodiments, wherein a gate or door is secured to at least one of the upper portion, the middle portion, and the lower portion of the hinge assembly.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments. Any dimensions shown in the drawing are not limiting to the disclosure or the claims.

FIG. 1 is an isometric view of a gate assembly and a gate according to the prior art;

FIG. 2 illustrates an assembled isometric view of a hinge assembly having an upper portion, a middle portion, a bottom portion, and a hinge rod according to one or more embodiments;

FIG. 3 illustrates an exploded view of a hinge assembly having an upper portion, a middle portion, a bottom portion, a hinge rod, and bushings according to one or more embodiments;

FIG. 4 illustrates a side view of an upper portion of a hinge assembly having solid extensions and elongate grooves according to one or more embodiments;

FIG. 5 illustrates a side cross sectional view of an upper portion of a hinge assembly having solid extensions and a central bore according to one or more embodiments:

FIG. 6 illustrates a top plan view of an upper portion of a hinge assembly having a central bore according to one or more embodiments;

FIG. 7 illustrates a top plan view of a middle portion of a hinge assembly having a central bore according to one or more embodiments;

FIG. 8 illustrates a side elevation view of a middle portion of a hinge assembly having elongate fingers and elongate grooves according to one or more embodiments;

FIG. 9 illustrates a side cross sectional view of a middle portion of a hinge assembly having elongate fingers, grooves, and a central bore according to one or more embodiments;

FIG. 10 illustrates a top plan view of a lower portion of a hinge assembly having a central bore according to one or more embodiments;

FIG. 11 illustrates an isometric view of a lower portion of a hinge assembly having a central bore according to one or more embodiments; and

FIG. 12 illustrates a side view of a lower portion of a hinge assembly having a central bore according to one or more embodiments; and

FIG. 13 is an isometric view of the hinge assembly assembled to a barrier shown in the form of a gate.

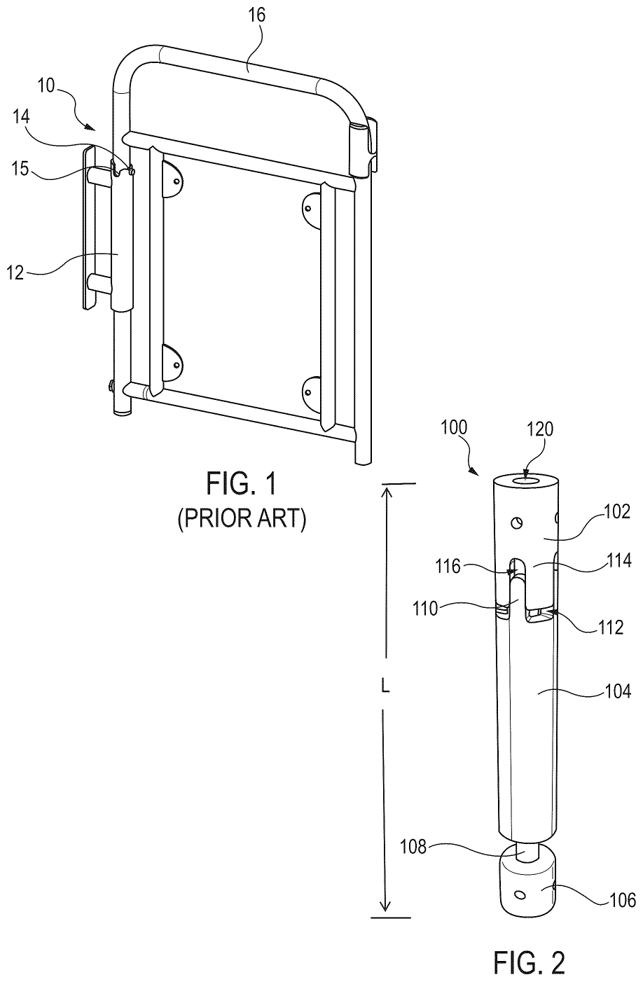

### DETAILED DESCRIPTION

Before describing several exemplary embodiments of the disclosure, it is to be understood that the disclosure is not limited to the details of construction or process steps set forth in the following description. The disclosure is capable of other embodiments and of being practiced or being carried out in various ways.

The term “horizontal” as used herein is defined as a plane parallel to the plane or surface of a floor, a deck or a deck of a boat, regardless of its orientation. The term “vertical” refers to a direction perpendicular to the horizontal as just defined. The term “non-horizontal” includes planes that are at 20 degrees to 120 degrees from a horizontal plane, including, but not limited to vertical. The phrases “side mount” and “side mounted” refer to a table leg that is affixed to a non-horizontal surface of a room, a deck, a vehicle, a boat or a motorhome. For example, a side mounted or socket retainer is not affixed to the deck or gunwale of a boat but instead is affixed to a sidewall surface of a boat such as a wall, a coaming or other non-horizontal surface. Terms, such as “above”, “below”, “bottom”, “top”, “side” (as in “sidewall”), “higher”, “lower”, “upper”, “over”, and “under”, are defined with respect to the horizontal surface as shown in the figures.

The term “on” indicates that there is direct contact between elements. The term “directly on” indicates that there is direct contact between elements with no intervening elements.

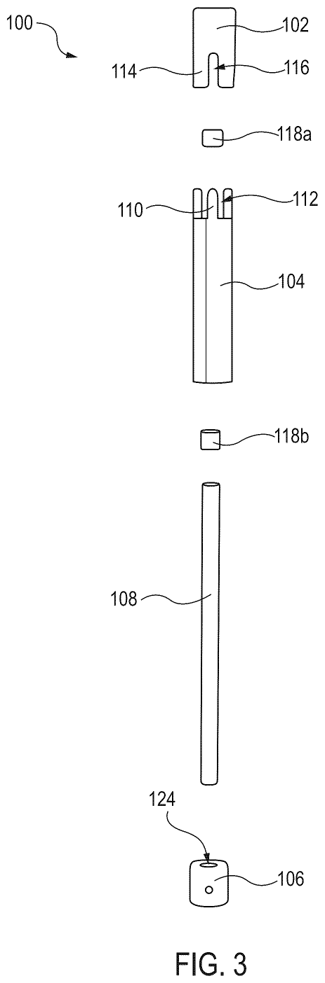

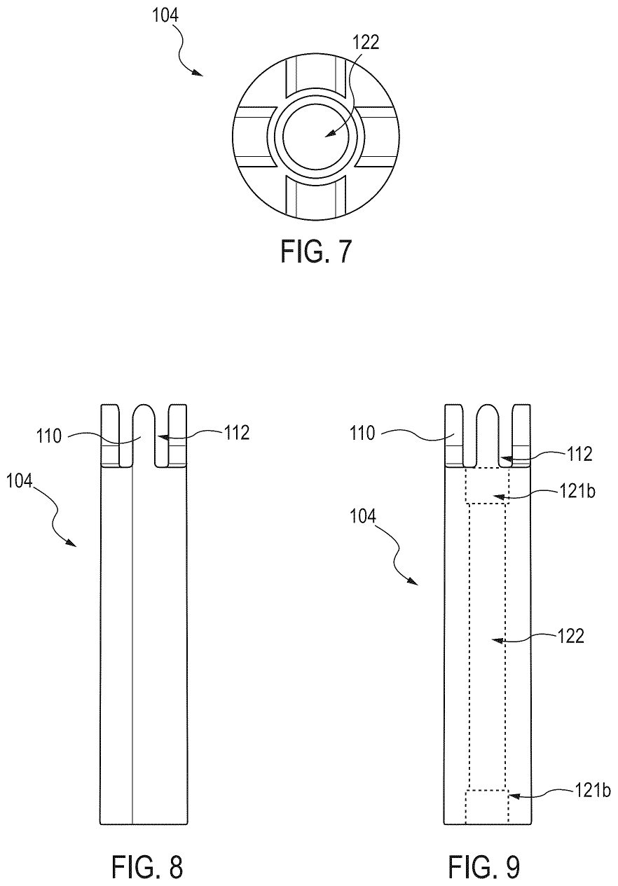

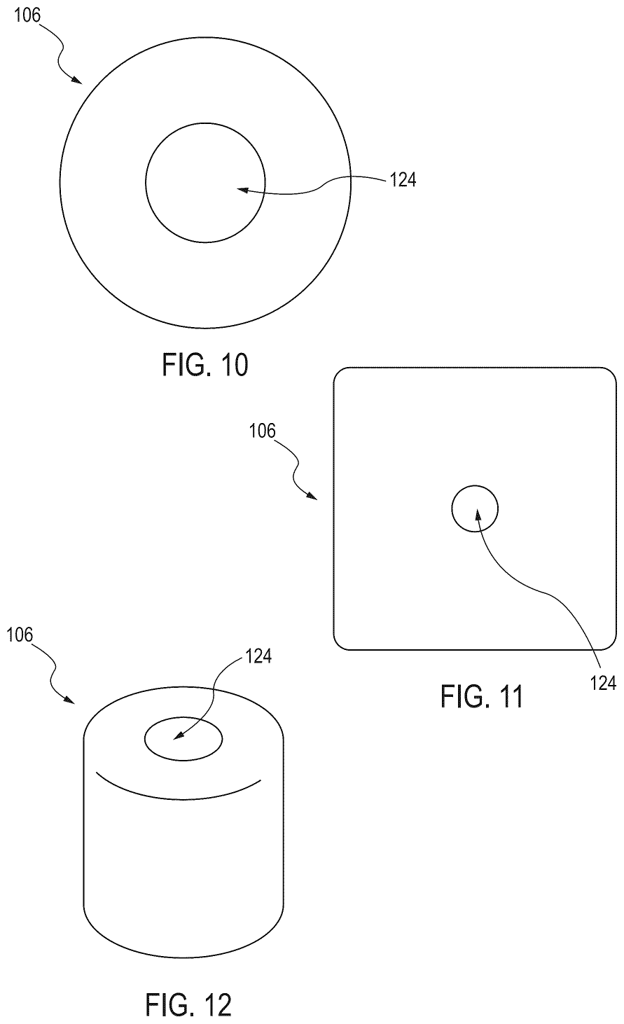

Referring now to FIGS. 2-13 in one or more embodiments, a hinge assembly 100 comprises an a first portion 102 comprising a central bore 120, a middle portion 104 comprising a central bore 122, and a second portion 106 comprising a central bore 124. The hinge assembly 100 and each of the first portion 102, the middle portion 104, and a hinge rod 108, which is configured to be received within the central bores 120, 122, and 124 each define a length “L”. The hinge assembly 100 further comprises the hinge rod 108, which is configured to be received within each of the central bores 120, 122 and 124.

The second portion 106, the middle portion 104 and the first portion 102 are configured to be mounted to the hinge rod 108 through the central bore 124 of the second portion 106, the central bore 122 of the middle portion 204 and the central bore 120 of the first portion 102. The central bore 124 of the second portion, the central bore 122 of the middle portion 104 and the central bore 120 of the upper first are each configured to receive the hinge rod 108, so that the first portion 102 and the middle portion 104 rotate freely around the hinge rod 108. In some embodiments, the second portion 106 is affixed to the hinge rod 108, for example, by a set screw (not shown).

The middle portion 104 comprises middle portion elongate fingers 110 and middle portion elongate grooves 112. The middle portion elongate fingers 110 are separated by the middle portion elongate grooves 112. The middle portion elongate fingers 110 and middle portion elongate grooves extend along a length “L” of the middle portion 104. The first portion 102 comprises first portion elongate fingers 114 separated by first portion elongate grooves 116. In some embodiments, the orientation of the first portion 102 and the second portion 106 are reversed. Stated another way, the orientation of the assembly 100 may be rotated 180 degrees about an x-y plane so that the first portion 102 is positioned beneath the middle portion 104. The first portion elongate grooves 116 in some embodiments are complementary to the middle portion 104 elongate fingers 110. Likewise, in some embodiments, the first portion elongate fingers 114 are complementary to the middle portion elongate grooves 112. As used herein, “complementary” refers to the fingers of one part fitting within the grooves of the other part.

Accordingly, in the embodiment shown, the middle portion 104 includes the elongate fingers 110 extending upwardly separated by the elongate grooves 112, and the first portion 102 is an upper portion and comprises the complementary elongate grooves 116 separated by first portion elongate fingers 114 that fit within the middle portion elongate grooves 112. Therefore, in the embodiments shown, the hinge assembly 100 is oriented so that the first portion 102 is located above the middle portion and the second portion 106 is located below the middle portion. However, this orientation can be reversed so that hinge assembly 100 is oriented so that the first portion 102 is located below the middle portion 104 and the second portion 106 is located above the middle portion.

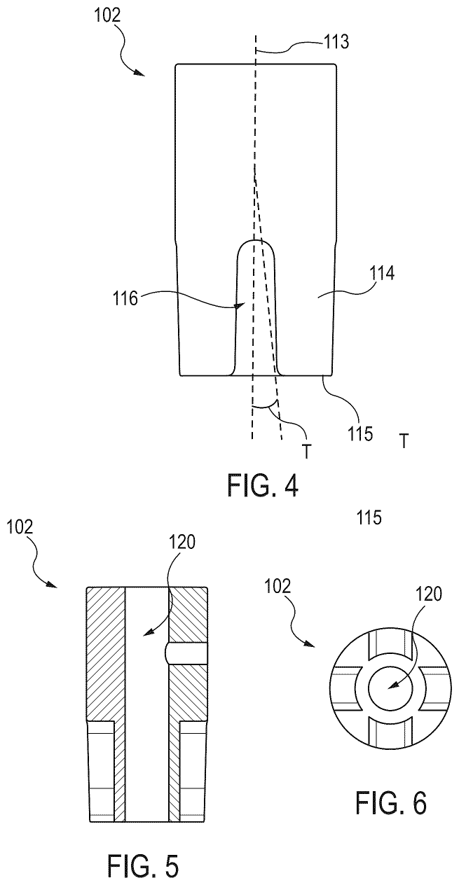

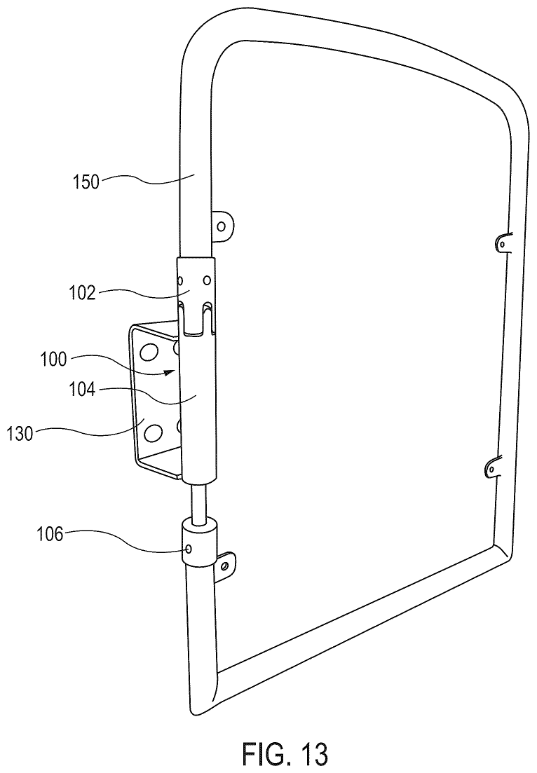

The complementary elongate grooves 116, as shown in FIG. 4 have a taper “T” defining an angle with respect to a tangent that intersects with a perpendicular line 113 that is perpendicular to a bottom surface 115 of the first portion 102. The elongate fingers 110 have a similar taper T (now shown) to the taper T of the complementary elongate grooves 116. It will be appreciated that this taper T on the complementary elongate grooves 116 and the elongate fingers 110 are configured so that when a gate 150 (shown in FIG. 13) is mounted to the hinge assembly 100, the complementary elongate grooves 116 bottom out in the elongate fingers 110 for a snug and firm fit that prevents the hinge assembly 100 and the gate from rattling.

In some embodiments, the first portion 102 and the second portion 106 are fixedly mounted to the hinge rod 108 and the middle portion 104 is slidably mounted to the hinge rod 108. In some embodiments, the elongate fingers 110 of the middle portion 104, and the complementary elongate grooves 116 interlock with each other creating a complementary pair when the hinge assembly 100 is in a fixed position under a force of gravity.

In some embodiments (not shown), the complementary elongate grooves 116 are on a middle portion 104, and the elongate fingers 110 are on one of the first portion 102, which interlock with each other creating a complementary finger/groove pair when the hinge is in a fixed position under a force of gravity. The interlocking of the finger/groove pair is under a force of gravity according to one or more embodiments, and no additional biasing by a spring, or any other force is required to secure the hinge assembly in place.

In some embodiments, there are least 2 and less than 10 complementary finger/groove pairs. In other embodiments, there are from 2-3, 2-4, 2-5, 2-6, 2-7 or 2-8 finger/groove pairs.

In some embodiments, the taper T is in a range of from 1 to 15 degrees, 1 to 14 degrees, 1 to 13 degrees, 1 to 12 degrees, 1 to 11 degrees, 1 to 10 degrees, 1 degree to 9 degrees, 1 to 8 degrees, 1 to 7 degrees, 1 to 6 degrees, 1 to 5 degrees, 1 to 4 degrees or 1 to 3 degrees. In specific embodiments, the taper T is in a range of from 2 to 12 degrees, 2 to 11 degrees, 2 to 10 degrees, 2 to 9 degrees, 2 to 8 degrees, 2 to 7 degrees, 2 to 6 degrees, 2 to 5 degrees, 2 to 4 degrees, 2 to 3 degrees, 5 to 12 degrees, 5 to 11 degrees, 5 to 10 degrees, 5 to 9 degrees, 8 to 12 degrees, 8 to 11 degrees or 8 to 10 degrees. When the taper is too large, the interlock of fingers and complementary elongate grooves may not be optimal, which can cause the hinge to rattle because the fingers fit too loosely within the complementary elongate grooves. In one or more embodiments, the taper of the elongate grooves 112 of the middle portion 104 is equal to the taper T of the elongate fingers 114 of the first portion 102. Similarly, the taper T of the elongate fingers 110 of the middle portion 104 is equal to the taper T of the elongate grooves 116 of the first portion 102.

In one or more embodiments elongate fingers 110 have a length to width aspect ratio in a range of from 2.5:1 to 10:1, for example 2.5:1 to 9:1, 2.5:1 to 8:1, 2.5:1 to 7:1, 2.5:1 to 6:1, 2.5:1 to 5:1, 2.5:1 to 4:1 or 2.5:1 to 3:1. The length to width is optimized to provide a stable and snug fit and interlock of the elongate fingers 110 and the complementary elongate grooves 116. In one or more embodiments, the first portion, the middle portion and the third portion comprise solid cast metal material.

In some embodiments the middle portion further comprises polymeric bushings, an upper bushing 118a and a lower bushing 118b. The polymeric bushings of some embodiments is made from bronze metal, paraformaldehyde (sold under the name Delrin) or nylon. In some embodiments, the polymeric bushings are fitted within pockets 121a and 121b shown in FIG. 9.

Referring now to FIG. 13, a gate assembly is shown as comprising the hinge assembly 100 as shown and described herein according to one or more embodiments and affixed to a gate 150, wherein the gate is secured to at least one of the first portion 102, the middle portion 104, and the second portion 106 of the hinge assembly. In some embodiments, the gate is secured to the first portion 102. In some embodiments, the gate is secured to the second portion 106. In some embodiments, the gate is secured to the middle portion 104. In the non-limiting embodiment shown, the middle portion 104 is affixed to a mounting fixture, which is configured to be mounted to a member defining an opening, for example, a stud of a building structure, a fence post, a wall or any other suitable structure. It will be understood that the embodiment in FIG. 13 showing the gate 150 is just one example of a barrier to entry. In other embodiments, the barrier to entry can be a door of structure, a cabinet door for a cabinet that is used in a building or a vehicle.

The gate 150 can be secured by suitable bolts, screws, tack weld or any other suitable securement method. The various components of the hinge assembly other that the bushings may be made from a suitable metal such as aluminum or stainless steel.

Reference throughout this specification to “one embodiment,” “certain embodiments,” “one or more embodiments” or “an embodiment” means that a particular feature, structure, material, or characteristic described in connection with the embodiment is included in at least one embodiment of the disclosure. Thus, the appearances of the phrases such as “in one or more embodiments,” “in certain embodiments,” “in one embodiment” or “in an embodiment” in various places throughout this specification are not necessarily referring to the same embodiment of the disclosure. Furthermore, the particular features, structures, materials, or characteristics may be combined in any suitable manner in one or more embodiments.

Although the disclosure herein has been described with reference to particular embodiments, it is to be understood that these embodiments are merely illustrative of the principles and applications of the present disclosure. It will be apparent to those skilled in the art that various modifications and variations can be made to the method and apparatus of the present disclosure without departing from the spirit and scope of the disclosure. Thus, it is intended that the present disclosure include modifications and variations that are within the scope of the appended claims and their equivalents.

What is claimed is:

1. A hinge assembly comprising:
a first portion comprising a central bore and first portion elongate fingers separated by first portion elongate grooves extending along a length of the first portion;
a middle portion comprising a central bore and middle portion elongate fingers separated by middle portion elongate grooves extending along a length of the middle portion;
a second portion comprising a central bore; and
a hinge rod configured to be received in the central bore of the second portion, the central bore of the middle portion and the central bore of the first portion, and the first portion elongate fingers are configured to be received within the middle portion elongate grooves and the middle portion elongate fingers are configured to be received within the first portion elongate grooves.

2. The hinge assembly of claim 1, wherein the hinge assembly is oriented so that the first portion is located above the middle portion and the second portion is located below the middle portion.

3. The hinge assembly of claim 1, wherein the hinge assembly is oriented so that the first portion is located below the middle portion and the second portion is located above the middle portion.

4. The hinge assembly of claim 1, wherein the first portion and the second portion are fixedly mounted to the hinge rod and the middle portion is slidably mounted to the hinge rod.

5. The hinge assembly of claim 4, wherein the middle portion elongate fingers are configured to interlock with the first portion elongate grooves, creating a complementary finger/groove pair when the hinge assembly is in a fixed position.

6. The hinge assembly of claim 4, wherein the middle portion elongate grooves interlock with the second portion elongate fingers, creating a complementary finger/groove pair when the hinge assembly is in a fixed position.

7. The hinge assembly of claim 4, wherein there are at least 2 and less than 9 complementary finger/groove pairs.

8. The hinge assembly of claim 4, wherein the middle portion elongate grooves comprise a taper in a range of from 1 degree to 15 degrees.

9. The hinge assembly of claim 8, wherein the first portion elongate fingers comprise a taper in a range of 1 degree to 15 degrees and that is equivalent to the taper of the middle portion elongate grooves.

10. The hinge assembly of claim 8, wherein the taper of the middle portion elongate grooves is in a range of from 3 degrees to 10 degrees.

11. The hinge assembly of claim 10, wherein the first portion elongate fingers comprise a taper in a range of 3 degree to 10 degrees and that is equivalent to the taper of the middle portion elongate grooves.

12. The hinge assembly of claim 4, wherein the middle portion elongate fingers and second portion elongate fingers have a length to width aspect ratio in a range of from 2.5:1 to 10:1.

13. The hinge assembly of claim 1, wherein the second portion, the middle portion and the first portion comprise solid cast metal material.

14. The hinge assembly of claim 13, wherein the middle portion comprises bushings.

15. The hinge assembly of claim 14, wherein the middle portion comprises two bushings made from a material selected from bronze, nylon and Delrin.

16. The hinge assembly of claim 14, wherein the two bushings are mounted within pockets of the middle portion.

17. A barrier assembly comprising the hinge assembly of claim 1 and a gate or a door, wherein the gate or the door is secured to at least one of the first portion, the middle portion, and the second portion.

18. The barrier assembly of claim 17, wherein the gate or the door is secured to the first portion.

19. The barrier assembly of claim 18, wherein the gate or the door is secured to the second portion.

20. The barrier assembly of claim 19, wherein the gate or the door is secured to the middle portion.
